(19) United States
(12) Patent Application Publication
(10) Pub. No.: US 2014/0261703 A1
(43) Pub. Date: Sep. 18, 2014

(54) METHOD TO DETECT VALVE DEVIATION

(71) Applicant: Applied Materials, Inc., Santa Clara, CA (US)

(72) Inventors: Daemian RAJ, Fremont, CA (US); Juan Carlos ROCHA-ALVAREZ, San Carlos, CA (US); Jason K. FOSTER, San Jose, CA (US); Bo XIE, San Jose, CA (US); Alexandros T. DEMOS, Fremont, CA (US)

(73) Assignee: APPLIED MATERIALS, INC., Santa Clara, CA (US)

(21) Appl. No.: 14/188,629

(22) Filed: Feb. 24, 2014

Related U.S. Application Data
(60) Provisional application No. 61/798,568, filed on Mar. 15, 2013.

(51) Int. Cl. F16K 37/00

(52) U.S. Cl. CPC F16K 37/0091
USPC 137/1; 137/557

(57) ABSTRACT

Methods for detecting valve leakage and apparatus for the same are provided. In one embodiment, a method for detecting a valve leakage includes flowing a gas through a diverter valve, determining a pressure in a gas source provided to the diverter valve, comparing the determined pressure value with an expected pressure value, and generating a signal in response to the comparison.

### CROSS-REFERENCE TO RELATED APPLICATIONS

This application claims priority to U.S. Provisional Patent Application Ser. No. 61/798,568, filed on Mar. 15, 2013, which is herein incorporated by reference.

### BACKGROUND OF THE INVENTION

1. Field of the Invention

Embodiments of the present invention generally relate to a method for detecting a valve deviation, and apparatus for same. Additionally, embodiments of the present invention also relate to a method for depositing a film.

2. Background of the Invention

In the manufacture of integrated circuits, precise control of various processing parameters is required for achieving consistent results within a substrate, as well as the results that are reproducible from substrate to substrate. As the geometry limits of the structures for forming semiconductor devices are pushed against technology limits, tighter tolerances and precise process control are critical to fabrication success. However, with shrinking geometries, precise critical dimension and process control has become increasingly difficult.

Conventional deposition processes, such as chemical vapor deposition (CVD), supply reactive gasses (i.e., precursor gasses) to the substrate surface to produce plasma which is deposited as a desired film on the substrate. If the reactive gasses are not precisely controlled, processing results may lead to non-uniform film deposition. For example, gas valve leaks may lead to non-uniform gas delivery resulting in delaminated film on the substrate surface. Although conventional gas panel systems have proven to be robust performers at larger critical dimensions, existing techniques for controlling gas delivery is one area where improvement will contribute to the successful fabrication of semiconductor devices with reduced geometries.

Therefore, there is a need for an improved method of gas delivery by detecting a valve deviation from a predetermined standard.

### SUMMARY OF THE INVENTION

Embodiments of the present invention generally relate to a method for detecting a valve deviation, and using the same. Additionally, embodiments of the present invention also relate to a method for depositing a film.

Methods for detecting valve leakage and apparatus for the same are provided. In one embodiment, a method for detecting a valve leakage includes flowing a gas through a diverter valve, determining a pressure in a gas source provided to the diverter valve, comparing the determined pressure value with an expected pressure value, and generating a signal in response to the comparison.

In another embodiment, computer-readable storage medium is provide for detecting valve leakage. The computer-readable storage medium, storing code for execution by a central processing unit (CPU), wherein a code, when executed by a CPU, cause performance of a method for detecting leakage in a valve, the method including flowing a gas through a diverter valve, determining a pressure in a gas source provided to the diverter valve, comparing the determined pressure value with an expected pressure value, and generating a signal in response to the comparison.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a schematic representation of a deposition system, according to one embodiment of the present invention;

FIG. 2 is a schematic representation of a valve assembly; and

FIG. 3 is a flow diagram of a method for detecting a valve deviation.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

FIG. 1 is a schematic diagram of one embodiment of a deposition system 100 suitable for depositing a film. A suitable processing chamber 103, which may be adapted for use with the teachings disclosed herein, includes, for example, the Producer Processing system available from Applied Materials, Inc. of Santa Clara, Calif. Suitable processing chambers include a CVD chamber, a plasma enhanced chemical vapor deposition (PECVD) chamber, a physical vapor deposition (PVD) chamber, etch chamber or other vacuum chambers used for vacuum processing. For clarity and ease of description, a CVD chamber utilizing embodiments of the invention described herein is described below with reference to FIGS. 1 and 2.

The processing chamber 103 includes a chamber body 102 and a lid 104 which encloses an interior volume 106. The chamber body 102 is typically fabricated from aluminum, stainless steel or other suitable material. The chamber body 102 generally includes sidewalls 108 and a bottom 110. A substrate support pedestal access port (not shown) is generally defined in the sidewall 108 and selectively sealed by a slit valve to facilitate entry and egress of a substrate 105 from the processing chamber 103. An exhaust port 126 is defined in the chamber body 102 and couples the interior volume 106 to a pump system 128. The pump system 128 generally includes one or more pumps and throttle valves utilized to evacuate and regulate the pressure of the interior volume 106 of the processing chamber 103.

A gas panel 158 is coupled to the processing chamber 103 to provide process and/or cleaning gases to the interior volume 106 of the processing chamber 103. The gas panel 158 includes a first precursor gas source 171 and a first carrier gas source 173. In one embodiment, the first precursor gas source 171 provides a silicon rich precursor. An example of a suitable silicon rich precursor is methyldiethoxsilane (mDEOS), among others. Suitable carrier gases include helium, nitrogen or other suitable non-reactive gas.

The first precursor gas source 171 and the first carrier gas source 173 are coupled to a first vaporizer 180. In one embodiment, a first sensor 186 is disposed between the first carrier gas source 173 and the first vaporizer 180 to provide a complete-holistic diagnostic of the health of the flow of the first carrier gas 171 throughout the system 100. The first sensor 186 may be a pressure sensor, a mass flow meter or other sensor suitable for providing a metric indicative of the flow from the first carrier gas source 173. The first vaporizer 180 is coupled to a first valve assembly 190.

The gas panel 158 includes also includes a second precursor gas source 172 and a second carrier gas source 174. In one embodiment, the second precursor gas source 172 provides a carbon rich precursor. Examples of a suitable carbon rich precursor include alpha-terpinene (ATRP) and bicyclo [2.2.1]hepta-2,5-diene (BCHD), among others. Suitable carrier gases include helium, nitrogen or other suitable non-reactive gas.

The second precursor gas source 172 and the second carrier gas source 174 are coupled to a second vaporizer 181. In one embodiment, a second sensor 188 is disposed between the second carrier gas source 174 and the second vaporizer 181 to provide a complete-holistic diagnostic of the health of the flow of the second carrier gas 174 throughout the system 100. The second sensor 188 may be a pressure sensor, a mass flow meter or other sensor suitable for providing a metric indicative of the flow from the second carrier gas source 174. The second vaporizer 181 is coupled to a second valve assembly 192.

The gas panel 158 includes also includes an oxygen source 175. The oxygen source 175 provides an oxidizing gas, such as O₂, to the processing chamber 103 for mixing with the gas mixtures entering the processing chamber 103 from either or both of the valve assemblies 190, 192.

The valve assemblies 190, 192 are configured as diverter valves as to selectively couple the vaporizers 180, 181 to the processing chamber the exhaust port 126 of the processing chamber 103 downstream of a pumping system 128) via a by-pass line 198. Details of the valve assemblies 190, 192 will be discussed further below with respect to FIG. 2.

In the embodiment depicted in FIG. 1, one or more chamber inlet ports 132 are provided in the lid 104 to allow gases to be delivered from the gas panel 158 to the interior volume 106 of the processing chamber 103. A showerhead assembly 130 is coupled to an interior surface 114 of the lid 104. The showerhead assembly 130 includes a plurality of apertures that allow gases to flow through the showerhead assembly 130 from the chamber inlet port 132 into the interior volume 106 of the processing chamber 103 in a predefined distribution across the surface of a substrate support pedestal 148.

An RF source power source 143 is coupled through a matching network 141 to the showerhead assembly 130. The RF source power supply 143 is capable of generating up to about 3000 W at a tunable frequency in a range from about 50 kHz to about 13.56 MHz.

In one embodiment, the showerhead assembly 130 is configured with a plurality of zones (not shown) that allow for separate control of gas flowing into the interior volume 106 of the processing chamber 103. In one embodiment the showerhead assembly 130 has an inner zone and an outer zone that are separately coupled to the gas panel 158 through separate inlet ports 132.

The substrate support pedestal 148 is disposed in the interior volume 106 of the processing chamber 103 facing the gas distribution showerhead assembly 130. The substrate support pedestal 148 holds the substrate 105 during processing. The substrate support pedestal 148 generally includes a plurality of lift pins (not shown) disposed there which are configured to lift the substrate 105 from the substrate support pedestal 148 and facilitate exchange of the substrate 105 with a robot (not shown) in a conventional manner.

The substrate support pedestal 148 may optionally include at least one embedded heater 176, to control the lateral temperature profile of the substrate support pedestal 148. The heater 176 is regulated by a power source 178. In operation, a backside gas is provided at controlled pressure into the gas passages to enhance the heat transfer between an electrostatic chuck (not shown) and the substrate support pedestal 148.

The above-described system 100 can be controlled by a processor based system controller such as the controller 150. The controller 150 includes a programmable central processing unit (CPU) 120 that is operable with a memory 184, a mass storage device, an input control unit, and a display unit. The system controller further includes well-known support circuits 113 such as power supplies, clocks, cache, input/output (I/O) circuits, and the like, coupled to the various components of the processing chamber 103 to facilitate control of the deposition process. The controller 150 also includes hardware for monitoring substrate processing through sensors in the processing chamber 103, including the sensors 186, 188 monitoring the carrier gas flow. Other sensors that measure system parameters such as substrate temperature, chamber atmosphere pressure and the like, may also provide information to the controller 150. All of the above elements are coupled to a control system bus 131.

To facilitate control of the processing chamber 103 and the gas panel 158, as described above, the CPU 120 may be one of any form of general purpose computer processor that can be used in an industrial setting, such as a programmable logic controller (PLC), for controlling various chambers and sub-processors. The memory 184 is coupled to the CPU 120, and is accessible to the system bus 131. The memory 184 is non-transitory and may be one or more of readily available memory such as random access memory (RAM), read only memory (ROM), floppy disk drive, hard disk, or any other form of digital storage, local or remote. The support circuits 113 are coupled to the CPU 120 for supporting the processor in a conventional manner. The deposition process is generally stored in the memory 184, typically as a software routine. The software routine may also be stored and/or executed by a second CPU (not shown) that is remotely located from the hardware being controlled by the CPU 120.

The memory 184 contains instructions that the CPU 120 executes to facilitate the operation of the system 100. The instructions in the memory 184 are in the form of program code such as a program that implements the method of the present invention. The program code may conform to any one of a number of different programming languages. In one embodiment, program code controls the delivery of the silicon precursor source 171 and the carrier gas source 173 as well as the carbon precursor 171 and the carrier gas source 173 with the oxygen source 175.

FIG. 2 is a schematic representation of the valve assembly 190. The valve assembly 192 may be similarly configured. In one embodiment, the valve assembly 190 is a diverter valve. The valve assembly 190 includes a gas inlet port 202, a normally open port 204, a normally closed port 206, a first actuation port 208 and a second actuation port 210. The normally open port 204 is coupled to the processing chamber 103 via the chamber delivery line 197. The normally closed port 206 is coupled to the foreline 160 via the by-pass line 198. Pressure applied to first actuation port 208 changes the open/closed state of the normally open port 204, while pressure applied to second actuation port 210 changes the open/closed state of the normally closed port 206.

Referring to FIGS. 1 and 2, the gas inlet port 202 of the first valve 190 is coupled by a gas delivery line 212 to the first vaporizer 180. The precursor and carrier source gas, having been mixed in the first vaporizer 180, flow into the first valve 190 through the gas inlet port 202 and exit the first valve 190 through the normally open port 204 when the first valve 190 is in a non-actuated state, i.e., no pressure is applied to the actuation ports 208, 210. The normally open port 204 is coupled to the processing chamber 103 by the chamber delivery line 197 and is configured to flow gas directly to the processing chamber 103. The mixed precursor and carrier source gas flows through the gas inlet port 202 and exits the first valve 190 through the normally closed port 206 when the first valve 190 is in an actuated state, i.e., a threshold pressure is applied to the actuation ports 208, 210. The normally closed-state port 206 is coupled to the foreline 160 via the by-pass line 198, thus allowing the mixed gases to by-pass the processing chamber 103 while still flowing from the gas panel 158. Flowing gas from the gas panel 158 directly into the foreline 160 allows the gas flows to fill the gas conduits and stabilize, thus allowing faster switching with less flow ramping when flow is switch from the foreline 160 to the processing chamber 103.

As discussed above, the gas flow path (i.e., to the processing chamber 103 or to the exhaust port 126) through the first valve 190 is controlled by the application of pressure to the first and second actuation ports 208, 210. The first actuation port 208 is coupled to an actuation fluid source 218 by a first actuation fluid delivery line 214, and the second actuation port 210 is coupled to the actuation fluid source 218 by a second actuation fluid delivery line 216. The actuation fluid delivery line 214, 216 are joined and coupled to the actuation fluid source 218 via a common control valve 220. The actuation fluid source 218 is configured to deliver an actuation fluid, such as compressed dry air (CDA), nitrogen gas (N₂), or other suitable fluid, to the first and second actuation ports 208, 210. In one embodiment, the control valve 220 is coupled to the controller 150, as described above, such that the actuation state of the first valve 190 may be selectively controlled to direct the mixed gases to the desired location, i.e., the foreline 160 or processing chamber 103).

The connections and operation of the second valve assembly 192 is substantially identical to that of the first valve assembly 190, expect for the second valve assembly 192 being configured to control the delivery of carbon rich precursor to the processing chamber 103.

Referring back to FIG. 1, location of the first and second sensors 186, 188 on the carrier source lines between the vaporizers 180, 181 and carrier sources 173, 174 advantageously isolates the sensors 186, 188 from the liquid precursors which may affect the reliability and service life of the sensors 186, 188. Moreover, the position of the sensors 186, 188 prior to the vaporizers 180, 181 positions the sensors 186, 188 in a location that is not heated. That is, the lines leading from the vaporizers 180, 181 to the processing chamber 103 and foreline 160, along with the vaporizers 180, 181 themselves are heated to prevent condensation and deposition of the precursor materials within the lines. Fluctuations in the temperature of these lines due to the changes in flow rates and/or material composition of gases flowing through the lines would negatively impact the ability to obtain precise and accurate information from the sensors 186, 188. Thus, the position of the sensors 186, 188 upstream of the vaporizers 180, 181 in the carrier gas lines reduces any impact on the information from the sensors 186, 188 due to temperature issues, thereby increasing the accuracy and reliability of the information obtained from the sensors 186, 188, along with increasing the service life of the sensors 186, 188.

FIG. 3 is a flow diagram of a method for detecting leakage in a valve. At block 302, the first precursor gas source 171, the first carrier gas source 173, the second precursor gas source 172 and the second carrier gas source 174 flow gas to the first and second diverter valves 190, 192, respectively. The precursor gases from the precursor sources 171, 172 and the carrier gases from the carrier gas sources 173, 174 mix in their respective vaporizers 180, 181 before flowing to the valve assemblies 190, 192.

In one exemplary mode of operation, the first valve assembly 190 is un-actuated to flow the silicon rich gas mixture to the processing chamber 103 while the second valve assembly 192 is in an actuated state to flow the carbon rich gas mixture to the foreline 160, by-passing the processing chamber 103. The silicon rich gas mixture is mixed with oxygen from the oxygen source 175 in the processing chamber 103 and energized to form plasma. The plasma causes the oxygen-silicon rich gas mixture to disassociate and deposit a silicon-based adhesion layer on the substrate 105.

Continuing the exemplary mode of operation, the first valve assembly 190 remains un-actuated to flow the silicon rich gas mixture to the processing chamber 103 while the second valve assembly 192 is switched to an un-actuated state to switch the flow of the carbon rich gas mixture from the foreline 160 to the processing chamber 103. The silicon rich gas mixture is combined with the carbon rich gas mixture, and flows into the processing chamber 103. The silicon rich/carbon rich gas mixture with is mixed with oxygen from the oxygen source 175 in the processing chamber 103 and energized to form a plasma. The plasma causes the oxygen—silicon rich/carbon rich gas mixture to disassociate and deposit a low-k (i.e., a dielectric constant less than about 4) dielectric layer on the silicon-based adhesion layer. The low-k dielectric layer may a portion proximate the adhesion layer that increases in carbon with distance from the adhesion layer.

At block 304, a metric indicative of the flow of carrier gas from the carrier gas sources 173, 174 is measured by their respective sensors 186, 188. The metric indicative of flow is provided to the controller 150. The measurement of the metric indicative of the flow may occur at any point in time in the example given above. Additionally, the metric indicative of the flow of the carrier gas may be obtained by the sensors 186, 188 during a non-processing period, for example, when no precursor gases are flowing so as to not waste expensive gases. The carrier gas may be directed through the valve assemblies into the foreline 160 so as not to generate particles or otherwise disrupt activities within the processing chamber 103.

The metric provided by the sensors 186, 188 may be utilized to determine a complete-holistic diagnostic of the health of the pressure flow of the carrier gases throughout the system 100. As such, any leaks, deviations or perturbations in the flow of the gas through the valves 190, 192 are sensed by the sensors 186, 188, which in response to, the controller 150 would generate a signal indicating the out of spec condition, i.e., leak or fault.

At block 306, the metric provided by the sensors 186, 188 is analyzed by the controller 150 to determine at least one of if the metric is outside of a predefined process window, above a threshold value, or below a threshold value. In one embodiment, the metric is compared to a predetermined value, for example of the pressure and/or flow rates of the carrier gas. The predetermined value may be determined by simulation, calculation or from test results. The predetermined value may be in the form of a numerical value, range of numerical value or data table. The predetermined value may be associated with a steady state flow condition or a ramping flow condition. The predetermined value may be associated with a steady state condition of the valve assembly or over a period that includes switching the actuation state of the valve. For example, if the valve assembly 192 is un-actuated and allowing flow of carrier gas (optionally having precursor gas mixed therewith) through the normally open port 204 and the valve assembly is actuated to switch the gas flow to the normally closed port 206, the signature of the metric, i.e., pressures and/or flow signature and be compared with the determined value associated with an expected signature under normal (e.g., expected) operating conditions. If a leak occurs, the metric of carrier gas flow sensed by the sensor and provided to the controller 150 would be outside of or deviate from the predetermined value expected for at those flow conditions. In one embodiment, the following equation may be used to determine the presence of a leak in the valve, wherein P1 is the recorded pressure (i.e., the metric obtained by the sensor) while flowing the carrier gas through the normally closed port 206, and P2 is the recorded pressure after actuating the flow of the carries gas to the normally open port 204:

$$\frac{( P 1 - P 2 )}{P 1} * 100 = comparative value$$

If the comparative value falls below 3% or above 8%, the controller 150 generates a signal that the valve failure is present at block 308. If the comparative value does not fall within the above range, normal operations continue. In one embodiment, if the comparative value does not fall within the predefined range, the controller 150 may generate a signal to continue normal operations.

The above invention is particularly beneficial in the deposition of low-K dielectric film which requires strict control of silicon rich and carbon rich precursors. For example, valve leaks (e.g., leaking carbon precursors to the processing chamber during a processing step that utilizes only silicon precursor) may ruin film quality, and for example, compromise the adhesion of the film and potentially allow future delaminating which may only be found well after deposition and after substantial investment in subsequent fabrication steps. Therefore, the above described invention advantageously allow more robust process control and effectively limits process defects due to valve leakage degradation in film quality.

While the foregoing is directed to the preferred embodiment of the present invention, other and further embodiments of the invention may be devised without departing from the basic scope thereof. The scope of the invention is determined by the claims which follow.

What is claimed is:

1. A method for detecting leakage in a valve, comprising:
flowing a gas through a diverter valve;
determining a pressure in a gas source provided to the diverter valve;
comparing the determined pressure value with an expected pressure value; and
generating a signal in response to the comparison.

2. A non-transitory computer-readable storage medium storing code for execution by a central processing unit (CPU), wherein a code, when executed by a CPU, performs an operation for detecting leakage in a valve, comprising:
flowing a gas through a diverter valve;
determining a pressure in a gas source provided to the diverter valve;
comparing the determined pressure value with an expected pressure value; and
generating a signal in response to the comparison.
